(19) United States
(12) Patent Application Publication
(10) Pub. No.: US 2025/0198020 A1
(43) Pub. Date: Jun. 19, 2025

(54) Hydrogen Gas Generation Using Ammonia

(71) Applicant: The Boeing Company, Arlington, VA (US)

(72) Inventor: Matthew Mostowitz, Snohomish, WA (US)

(21) Appl. No.: 18/637,695

(22) Filed: Apr. 17, 2024

Related U.S. Application Data
(60) Provisional application No. 63/610,027, filed on Dec. 14, 2023.

(51) Int. Cl. C25B 9/17; B64D 37/30; C25B 1/02; C25B 9/67

(52) U.S. Cl. CPC C25B 9/17; C25B 1/02; C25B 9/67; B64D 37/30

(57) ABSTRACT

A hydrogen gas generation system comprises a reactor chamber, an elongate cathode, an ammonia inlet, a hydrogen gas outlet, and a collection outlet. The reactor chamber has an input end and an output end. A wall of the reactor chamber between the input end and the output end is an anode. The elongate cathode extends between the input end and the output end through an interior of the reactor chamber. The ammonia inlet is positioned to introduce a liquid ammonia into the reactor chamber such that the liquid ammonia flows in a direction from the input end to the output end. The hydrogen gas outlet at the output end, wherein a hydrogen gas generated in the reactor chamber exits the reactor chamber through the hydrogen gas outlet. The collection outlet is at the output end. Nitrogenous compounds exit the reactor chamber through the collection outlet.

### CROSS-REFERENCE TO RELATED APPLICATION

This application claims the benefit of U.S. Provisional Patent Application Ser. No. 63/610,027, filed Dec. 14, 2023, and entitled “Hydrogen Gas Generation Using Ammonia,” which is incorporated herein by reference in its entirety.

### BACKGROUND INFORMATION

### 1. Field

The present disclosure relates generally to fuel generation and in particular, to generation of hydrogen gas from ammonia.

### 2. Background

Carbon emissions is of great concern in many industries. The reduction in carbon emissions has become a goal for many industries to reduce the effects of carbon on the climate. In the aviation industry, various efforts have been used to reduce carbon emissions. For example, airlines have performed route optimization, reduced taxiing times, and implemented strategies to reduce weight. Airlines have also made changes in maintenance schedules to increase fuel efficiency. Other efforts include retiring older aircraft and replacing those aircraft with more fuel efficient models.

With respect to aircraft, in addition to more fuel-efficient designs, newer propulsion systems are used that result in even lower levels of carbon emissions. For example, aircraft are being developed that operate with propulsion systems that use hydrogen gas as a fuel. Hydrogen offers an advantage over currently used fuels. Hydrogen gas burns cleanly and only releases water vapor as compared to the carbon emissions released from current fuels. The technologies involved in hydrogen gas propulsion systems include hydrogen internal combustion engines, fuel cells, gas turbines, and other components.

### SUMMARY

An embodiment of the present disclosure provides a hydrogen gas generation system comprising a reactor chamber, an elongate cathode, an ammonia inlet, a hydrogen gas outlet, and a collection outlet. The reactor chamber has an input end and an output end. A wall of the reactor chamber between the input end and the output end is an anode. The elongate cathode extends between the input end and the output end through an interior of the reactor chamber. The ammonia inlet is positioned to introduce a liquid ammonia into the reactor chamber such that the liquid ammonia flows in a direction from the input end to the output end. The hydrogen gas outlet is at the output end, wherein a hydrogen gas generated in the reactor chamber exits the reactor chamber through the hydrogen gas outlet. The collection outlet is at the output end. Nitrogenous compounds exit the reactor chamber through the collection outlet.

Another embodiment of the present disclosure provides a hydrogen gas generation system comprising a reactor chamber, an elongate cathode, an ammonia inlet, a hydrogen gas outlet, a collection outlet, and an ultrasonic transducer. The reactor chamber has an input end and an output end. A wall of the reactor chamber between the input end and the output end is an anode. The elongate cathode extends between the input end and the output end through an interior of the reactor chamber. The ammonia inlet is positioned to input a pressurized liquid ammonia tangentially into the reactor chamber such that the pressurized liquid ammonia flows in a helical path towards the output end. The hydrogen gas outlet is at the output end. The collection outlet is at the output end. Nitrogenous compounds exit the reactor chamber through the collection outlet. The ultrasonic transducer system is configured to generate ultrasonic signals that increases hydrogen generation rates within the reactor chamber.

Still another illustrative embodiment of the present disclosure provides a hydrogen gas generation system comprising reactors. Each reactor in the reactors comprises a reactor chamber having an input end and an output end, wherein a wall of the reactor is an anode; an elongate cathode extending between the input end and the output end through an interior of the reactor chamber; an ammonia inlet positioned to input a pressurized liquid ammonia tangentially into the reactor chamber such that the pressurized liquid ammonia flows in a helical path towards the output end; a hydrogen gas outlet at the output end; a collection outlet at the output end, wherein nitrogenous compounds exit the reactor chamber through the collection outlet; and an ultrasonic transducer system configured to generate ultrasonic signals that increases hydrogen generation rates within the reactor chamber. The reactors are connected in series with the collection outlet of one reactor being connected to the ammonia inlet of a next reactor in the series.

Yet another illustrative embodiment of the present disclosure provides a method of generating hydrogen gas. A liquid ammonia is input through an ammonia inlet into a reactor chamber, wherein the liquid ammonia flows through the reactor chamber and wherein the wall of the reactor chamber is an anode and an elongate cathode is in the reactor chamber. An electric field is generated in between the anode and the elongate cathode in the reactor chamber such that a hydrogen gas is extracted from the liquid ammonia. The hydrogen gas output from a hydrogen gas outlet exits the reactor chamber.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of an aircraft in communication with satellites in accordance with an illustrative embodiment;

FIG. 2 is an illustration of a block diagram of a gas generation environment in accordance with an illustrative embodiment;

FIG. 3 is an illustration of a block diagram of a hydrogen gas generation system using multiple reactors in accordance with an illustrative embodiment;

FIG. 4 is an illustration of an isometric view of a reactor in accordance with an illustrative embodiment;

FIG. 5 is an illustration of a top view of a reactor in accordance with an illustrative embodiment;

FIG. 6 is an illustration of a schematic diagram of a hydrogen gas generation system with multistage reactors in accordance with an illustrative embodiment;

FIG. 7 is an illustration of a flowchart of a process for generating hydrogen gas in accordance with an illustrative embodiment;

FIG. 8 is an illustration of a flowchart of a process for outputting nitrogenous compounds in generating nitrogen gas in accordance with an illustrative environment;

FIG. 9 is an illustration of a flowchart of a process for inputting liquid ammonia to generate hydrogen gas in accordance with an illustrative embodiment;

FIG. 10 is an illustration of a block diagram of an aircraft manufacturing and service method in accordance with an illustrative embodiment; and

FIG. 11 is an illustration of a block diagram of an aircraft in which an illustrative embodiment may be implemented.

### DETAILED DESCRIPTION

The illustrative embodiments recognize and take into account one or more different considerations as described herein. For example, currently, cryogenic hydrogen is used in platforms such as aircraft. This form of hydrogen requires large amounts of volume within the aircraft for storage as well as the equipment and energy to meet the temperature requirements to maintain the hydrogen at cryogenic temperatures.

Thus, it is desirable to have another mechanism to supply hydrogen for fuel rather than using cryogenic hydrogen. One alternative involves generation of hydrogen gas from ammonia. The hydrogen gas can be used with currently available hydrogen gas propulsion systems. In one illustrative example, hydrogen gas can be generated from ammonia using electric fields generated between an anode and a cathode. Ultrasonic signals can also be used to increase hydrogen generation rates. Further, the Lorentz force from magnetic fields can be used to further increase the generation rates of hydrogen gas.

The use of ammonia to generate hydrogen gas in an aircraft results in a higher volumetric hydrogen content in generating hydrogen gas as compared to storing cryogenic hydrogen in the aircraft. Further, liquid ammonia has less issues with respect to storage and use.

Thus, the illustrative embodiments provide a method, apparatus, and system for generating hydrogen gas. In one illustrative example, a hydrogen gas generation system comprises a reactor chamber, an elongate cathode, an ammonia inlet, a hydrogen gas outlet, and a collection outlet. The reactor chamber has an input end and an output end. A wall of the reactor chamber between the input end and the output end is an anode. The elongate cathode extends between the input end and the output end through an interior of the reactor chamber. The ammonia inlet is positioned to introduce a liquid ammonia into the reactor chamber such that the liquid ammonia flows in a direction from the input end to the output end. The hydrogen gas outlet is at the output end, wherein a hydrogen gas generated in the reactor chamber exits the reactor chamber through the hydrogen gas outlet. The collection outlet is at the output end. Nitrogenous compounds exit the reactor chamber through the collection outlet.

In another example, a hydrogen gas generation system comprises a reactor chamber, an elongate cathode, an ammonia inlet, a hydrogen gas outlet, a collection outlet, an ultrasonic transducer, and permanent magnets at the upper and lower caps of the reactor chamber. The reactor chamber has an input end and an output end. A wall of the reactor chamber between the input end and the output end is an anode. The elongate cathode extends between the input end and the output end through an interior of the reactor chamber. The ammonia inlet is positioned to input a pressurized liquid ammonia tangentially into the reactor chamber such that the pressurized liquid ammonia flows in a helical path towards the output end. The hydrogen gas outlet is at the output end. The collection outlet is at the output end. Nitrogenous compounds exit the reactor chamber through the collection outlet. The ultrasonic transducer system is configured to generate ultrasonic signals that increases hydrogen generation rates within the reactor chamber. The permanent magnets also increase the reaction rates within the reactor by applying the additional stress to the ammonia molecule via the application of the Lorenz force.

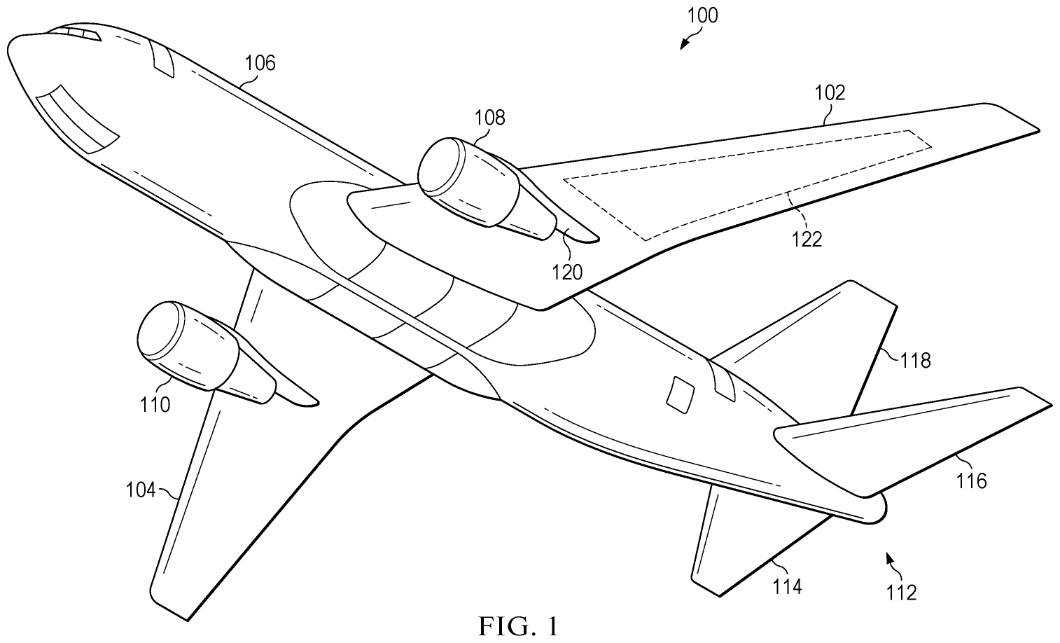

With reference now to the figures and, in particular, with reference to FIG. 1, a pictorial representation of an aircraft in communication with satellites is depicted in accordance with an illustrative embodiment. In this illustrative example, commercial airplane 100 has wing 102 and wing 104 attached to fuselage 106. Commercial airplane 100 includes engine 108 attached to wing 102 and engine 110 attached to wing 104.

Fuselage 106 has tail section 112. Horizontal stabilizer 114, horizontal stabilizer 116, and vertical stabilizer 118 are attached to tail section 112 of fuselage 106.

In this example, engine 108 and engine 110 are hydrogen propulsion systems in the form of hydrogen combustion engines that operate using hydrogen gas. Hydrogen gas generation systems that generate hydrogen gas can be located in a number of different locations in commercial airplane 100. For example, reactors in a hydrogen gas generation system for engine 108 can be located in at least one of engine 108, pylon 120, or fuel tank 122.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

The selection of locations for the reactors in the hydrogen gas generation system can be made to reduce the length of hydrogen gas fuel lines from reactors to engine 108. Additional reactors for the hydrogen gas generation system be placed in similar locations for engine 110 to generate hydrogen gas for engine 110. In this illustrative example, the reactors in the hydrogen gas generation system generate hydrogen gas from ammonia.

As used herein, “a number of” when used with reference to items, means one or more items. For example, “a number of different types of networks” is one or more different types of networks.

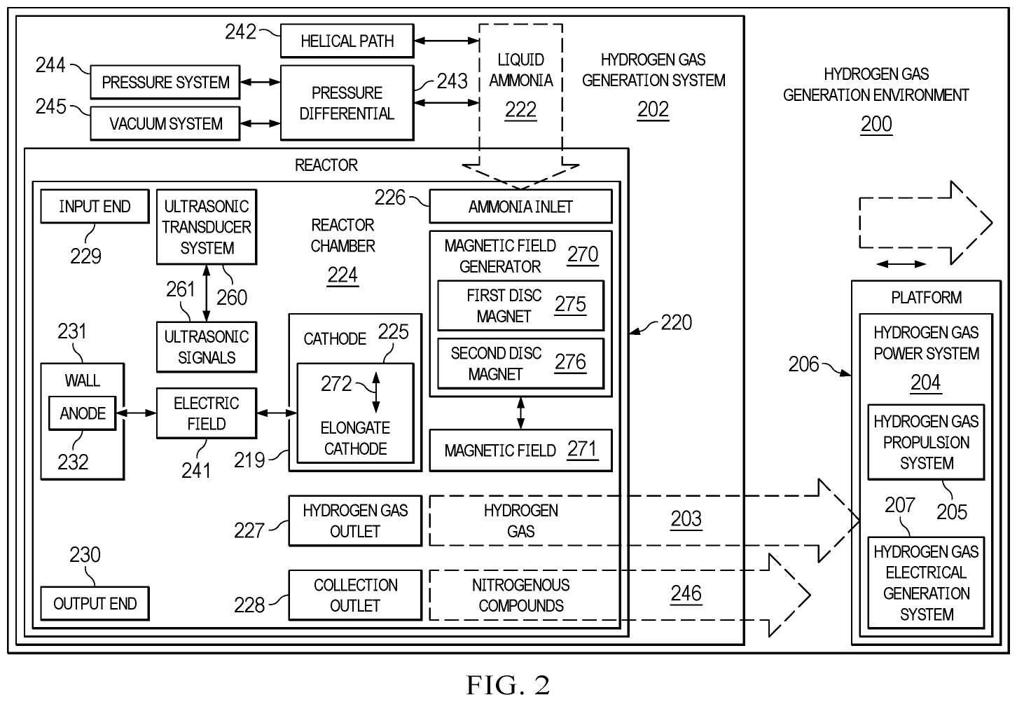

With reference now to FIG. 2, an illustration of a block diagram of a gas generation environment is depicted in accordance with an illustrative embodiment. In this illustrative example, hydrogen gas generation environment 200 includes components that can be implemented in commercial airplane 100 in FIG. 1.

In this illustrative example, hydrogen gas generation system 202 in hydrogen gas generation environment 200 generates hydrogen gas 203. In this example, hydrogen gas 203 is used by hydrogen gas power system 204 in platform 206.

Platform 206 can take a number of different forms. For example, platform 206 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, a building, and other suitable types of platforms.

In this illustrative example, hydrogen gas power system 204 uses hydrogen gas 203 to operate platform 206. For example, when platform 206 takes the form of a vehicle such as an aircraft, hydrogen gas power system 204 can be hydrogen gas propulsion system 205 that provides at least one of thrust or power to the aircraft. In another example, when platform 206 takes the form of a building, hydrogen gas power system 204 can be a hydrogen gas electrical generation system 207 that provides electricity to operate the building.

In this illustrative example, hydrogen gas generation system 202 comprises reactor 220. Reactor 220 uses liquid ammonia 222 to generate hydrogen gas 203. Reactor 220 includes a number of different components. As depicted, reactor 220 comprises reactor chamber 224, cathode 219, ammonia inlet 226, hydrogen gas outlet 227, and collection outlet 228.

Reactor chamber 224 is a physical structure with an interior. In this example, reactor chamber 224 has an input end 229 and an output end 230. In this example, wall 231 of reactor chamber 224 is anode 232. Further in this example, cathode 219 can be elongate cathode 225 within reactor chamber 224 and extends between the input end 229 and output end 230 through an interior of reactor chamber 224. Elongate cathode 225 can be a cylinder, a tube, a rod, or some other similar shape.

In this example, ammonia inlet 226 is positioned to introduce liquid ammonia 222 into the reactor chamber 224 such that the liquid ammonia 222 flows in a direction from input end 229 to output end 230.

In this illustrative example, hydrogen gas outlet 227 is located at output end 230, wherein hydrogen gas 203 generated in reactor chamber 224 exits reactor chamber 224 through hydrogen gas outlet 227. Collection outlet 228 is located at output end 230. In this example, nitrogenous compounds 246 exit reactor chamber 224 through collection outlet 228. An outlet or other component is at output end 230 when the outlet is closer to output end 230 than input end 229.

In these illustrative examples, one component is located at an end such as output end 230, the component may be physically located on the end. In another example, the component can be located proximate to the end. For example, hydrogen gas outlet 227 can be located on output end 230. In another example, collection outlet 228 can be on wall 231 some distance from output end 230. These locations are presented as examples and not meant to limit the manner in which the outlets can be positioned relative to output end 230. For example, collection outlet 228 can also be located on output end 230 in other illustrative examples.

In this example, hydrogen gas 203 is generated using anode 232 and elongate cathode 225. As depicted, electric field 241 generated between anode 232 and elongate cathode 225 causes hydrogen gas 203 to be generated from liquid ammonia 222. Hydrogen gas 203 generated by this process flows out of reactor chamber 224 through hydrogen gas outlet 227.

Not all of liquid ammonia 222 is used to generate hydrogen gas 203. In this illustrative example, nitrogenous compounds 246 flow out of reactor chamber 224 to collection outlet 228. Nitrogenous compounds 246 can include at least one of ammonia (NH3), nitrogen gas (N2), amide (NH2), and nitrogen hydrogen (NH).

In this example, the flow of liquid ammonia 222 through reactor chamber 224 can be controlled based on the position of ammonia inlet 226. For example, ammonia inlet 226 can be positioned to input liquid ammonia 222 tangentially into reactor chamber 224 such that liquid ammonia 222 flows in helical path 242 towards the output end 230.

In this example, the tangential positioning can be such that the ammonia inlet 226 introduces liquid ammonia 222 in a direction that is parallel to the surface of wall 231 in reactor chamber 224. Further, liquid ammonia 222 can be introduced such that it is in a direction relative to an axis 272 extending centrally through reactor chamber 224 in a manner that results in a swirling or vortex motion towards output end 230.

In this illustrative example, liquid ammonia 222 is introduced into reactor chamber 224 through ammonia inlet 226 with pressure differential 243. Further, in this example, pressure differential 243 is present in liquid ammonia 222 between input end 229 and output end 230 of reactor chamber 224.

Pressure differential 243 can be generated by pressure system 244. In this example, pressure system 244 causes liquid ammonia 222 to be a pressurized liquid that pushed towards the output end 230. In another example, pressure differential 243 can be generated by vacuum system 245. In this example, liquid ammonia 222 is under a vacuum and drawn towards output end 230. In yet another illustrative example, the pressure differential can be created by both pressure system 244 and vacuum system 245.

In these illustrative examples, additional components can be used to increase at least one of the efficiency or rate at which hydrogen gas 203 is generated. For example, hydrogen gas generation system 202 can also include ultrasonic transducer system 260. Ultrasonic transducer system is a physical system comprised of one or more ultrasonic transistors. Ultrasonic transducer system 260 generates ultrasonic signals 261 that increases hydrogen production rates within the reactor chamber 224 and de-gases elongate cathode 225 and anode 232.

Thus, in this example, the increase in reaction rate in generating hydrogen gas 203 can be the result of ultrasonic energy introduced into the flow of liquid ammonia 222. The de-gassing involves the agitation of hydrogen molecules on elongate cathode 225 and nitrogenous compounds 246 that form on anode 232. The de-gassing is a physical force on the hydrogen gas bubbles formed from electrolysis caused by electric field 241.

In this example, ultrasonic energy in ultrasonic signals 261 pushes hydrogen gas 203 formed on elongate cathode 225 to hydrogen gas outlet 227 and gas in nitrogenous compounds 246 formed on elongate cathode 225 to collection outlet 228. The energy in ultrasonic signals 261 agitates liquid ammonia 222 to release hydrogen gas 203 in addition to pushing the hydrogen gas 203 towards output end 230. Thus, ultrasonic signals 261 push hydrogen gas bubbles from elongate cathode 225 and nitrogenous compounds from anode 232.

In another illustrative example, hydrogen gas generation system 202 can also include magnetic field generator 270, which is a hardware system that generates magnetic field 271. In this example, magnetic field generator 270 generates magnetic field 271 in a field direction that is aligned with an axis 272 extending centrally through reactor chamber 224. In this example, axis 272 extends centrally through the elongate cathode 225. In this case, elongate cathode 225 also extends centrally within reactor chamber 224. In this example, magnetic field 271 increases hydrogen gas production using a Lorenz force.

In this example, liquid ammonia 222 is a polar molecule and can be affected by magnetic field 271 much like water. The generation of magnetic field 271 along axis 272 can increase hydrogen production by introducing the Lorentz force without additional energy being used to generate hydrogen gas 203. In other words, this increase in hydrogen gas production can occur without using additional input energy into hydrogen gas generation system 202. This can occur when magnetic field generator 270 uses permanent magnets that do not require energy to generate magnetic field 271.

In one example, magnetic field generator 270 comprises first disc magnet 275 and second disc magnet 276. First disc magnet 275 can be located proximate to ammonia inlet 226. Second disc magnet 276 can be proximal to hydrogen gas outlet 227. In this example, these disc magnets are permanent magnets that increase the reaction rates within the reactor. The magnetic fields generated by these magnets apply additional stress to the ammonia molecule via the application of the Lorenz Force. This occurs without needing energy to increase the hydrogen generation rate.

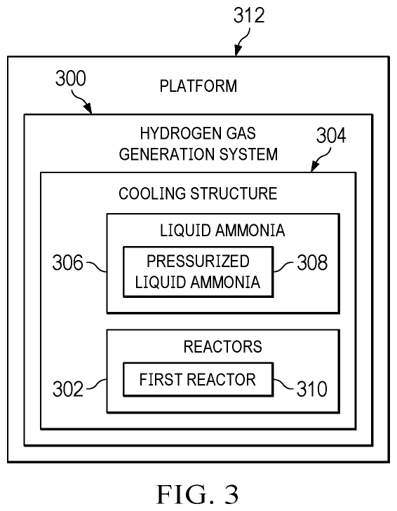

With reference next to FIG. 3, an illustration of a block diagram of a hydrogen gas generation system using multiple reactors is depicted in accordance with an illustrative embodiment. In this example, hydrogen gas generation system 300 is an example of a system that can also be used in hydrogen gas generation environment 200 to provide fuel for platform 206.

In this example, hydrogen gas generation system 300 comprises reactors 302. In this example, each reactor in reactors 302 can be implemented as reactor 220 in FIG. 2. In this example, reactors 302 are connected in series with the collection outlet of one reactor being connected to the ammonia inlet of the next reactor in the series. Additionally, cooling structure 304 can also be present in hydrogen gas generation system 300. In this example, reactors 302 are located within cooling structure 304. This cooling structure is a physical structure that provides cooling for reactors 302. In this example, liquid ammonia 306 is fed into cooling structure 304. Liquid ammonia 306 can be pressurized liquid ammonia 308. This liquid ammonia is fed into cooling structure 304 before being pumped into first reactor 310 in reactors 302.

In this example, cooling structure 304 and the other components in hydrogen gas generation system 300 can be located in platform 312, which can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, and a building.

The illustration of hydrogen gas generation environment 200 in the different components in this environment in FIGS. 2-3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, ammonia inlet 226 can be positioned to introduce liquid ammonia 222 into reactor chamber 224 such that liquid ammonia 222 flows towards the output end 230 without traveling in helical path 242. For example, the path can be a straight path, an angled path, or some other path other than helical path 242. As another example, other components such as fuel lines or fuel cells for the hydrogen gas fuel can be present although these components are not shown.

As another example, anode 232 can be input end 229 and cathode 219 can be output end 230. With this positioning of the electrodes, magnetic field generator 270 can include a first magnet that is part of or connected to wall 231 and a second magnet can be in the form a cylinder extending centrally within reactor chamber 224. These two magnets are configured to generate magnetic field 271 to point from wall 231 to the cylinder.

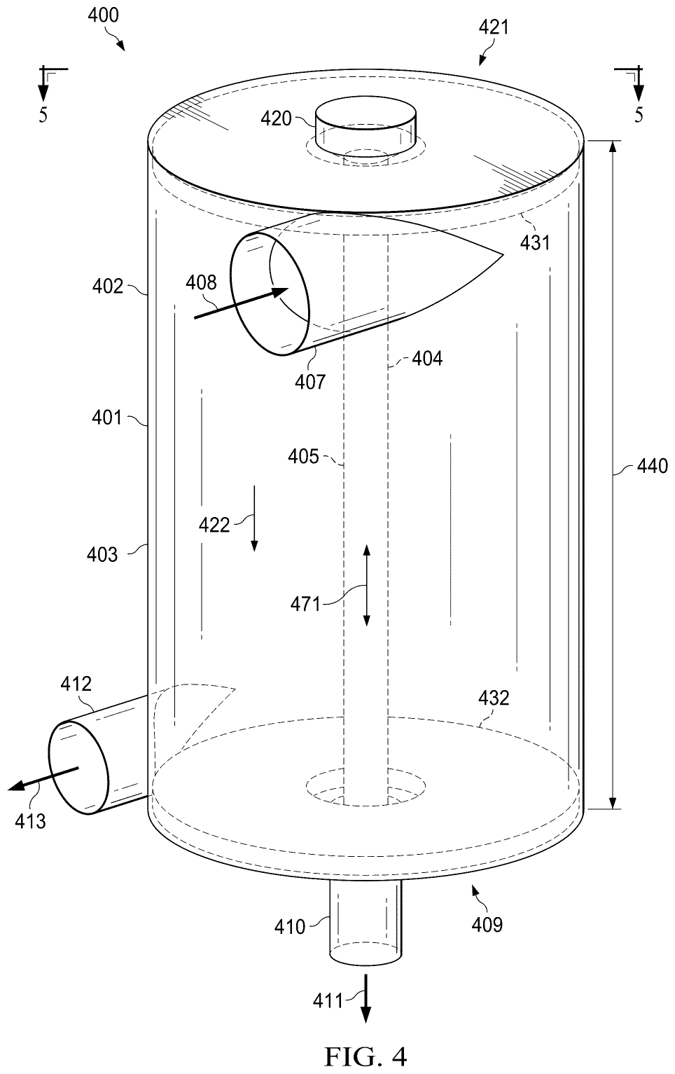

Next in FIG. 4, an illustration of an isometric view of a reactor is depicted in accordance with an illustrative embodiment. In this illustrative example, an isometric view of reactor 400 is an example of an implementation for reactor 220 in FIG. 2 and reactors 302 in FIG. 3.

As depicted, reactor 400 comprises reactor chamber 401, which is in the form of a cylinder with a cavity. In this example, anode 402 is wall 403 of reactor chamber 401. As depicted, cathode 404 is formed by inner cylinder 405. Axis 471 extends centrally through inner cylinder 405 and reactor chamber 401.

Ammonia inlet 407 is tangential to reactor chamber 401. This inlet introduces liquid ammonia 408 such that liquid ammonia 408 travels in a helical path towards the output end 409 of reactor chamber 401.

Further in this example, hydrogen gas outlet 410 is located at output end 409. In this example, hydrogen gas outlet 410 is located at output end 409 by being on output end 409. As depicted, hydrogen gas 411 flows out of reactor chamber 401 through hydrogen gas outlet 410. In this example, inner cylinder 405 for cathode 404 extends into hydrogen gas outlet 410.

As depicted, collection outlet 412 is also located at output end 409. In this example, collection outlet 412 is located at output end by being in wall 403 or in a location proximate to or adjacent to output and 409. Thus, being located at output end 409 can be on, proximate, or adjacent to output end 409. As shown in this example, nitrogenous compounds 413 flow out of reactor chamber 401 through collection outlet 412.

In this illustrative example, ultrasonic transducer 420 is located at input end 421 of reactor chamber 401. Ultrasonic transducer 420 is positioned to generate ultrasonic signals that travel in direction 422 through reactor chamber 401. This direction is aligned with axis 471 in this example.

Additionally, first disc magnet 431 and second disc magnet 432 are present and generate a magnetic field in a direction aligned with axis 471. This magnetic field increases the rate in generating hydrogen gas 411 using the Lorenz force. In this example, reactor chamber 401 of reactor 400 has height 440 that is six inches from input end 421 to output end 409.

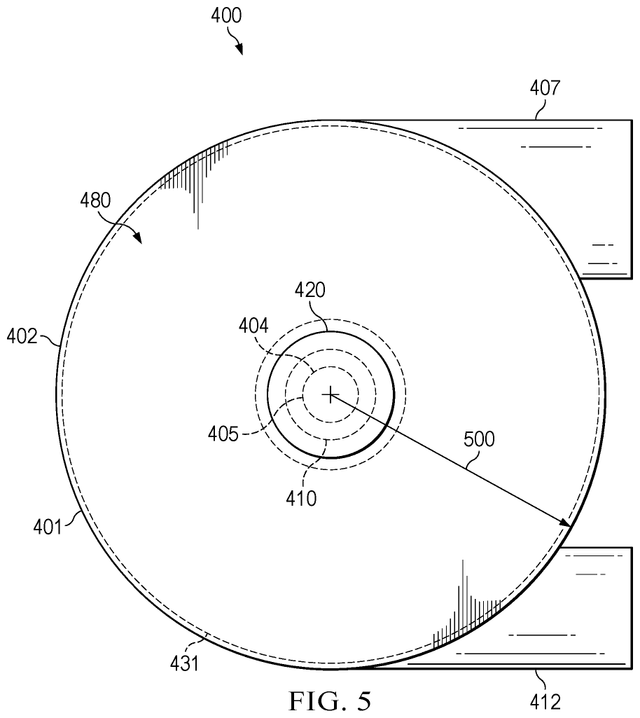

Turning next to FIG. 5, an illustration of a top view of a reactor is depicted in accordance with an illustrative embodiment. In this example, this view is a top view of input end 421 taken in the direction of lines 5-5 in FIG. 4. In this view, reactor chamber 401 has radius 500 that is two inches in this example.

The illustration of reactor 400 in FIG. 4 and FIG. 5 is provided as an example implementation of reactor 220 in FIG. 2 and reactors 302 in FIG. 3. This illustration is not meant to limit the manner in which a reactor can be implemented in other illustrative examples. In another illustrative example, reactor chamber 401 can have a conical shape such as a tapered cylinder. In yet another example, reactor chamber 401 can be a hexagonal or other type of cylinder. The particular shape selected for reactor chamber 401 can depend on the particular implementation or usage.

The illustration of reactor 400 in FIGS. 4-5 is one example of reactor 220 in FIG. 2 and not meant to limit the manner in which reactors can be implemented in other examples. For example, the position of the magnets and the electrodes can change. In another example, the anode can be input end 421 of reactor 400 and the cathode can be output end 409 of reactor 400. In this example, wall 403 and inner cylinder 405 are the magnets. Further, in the example, the magnetic field can be aligned to point from wall 403 to inner cylinder 405 of reactor 400.

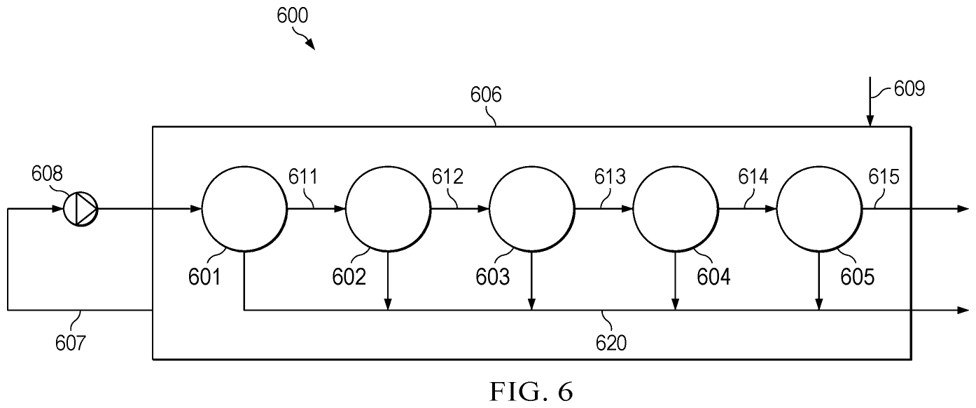

With reference next to FIG. 6, an illustration of a schematic diagram of a hydrogen gas generation system with multistage reactors is depicted in accordance with an illustrative embodiment. In this example, hydrogen gas generation system 600 is an example of an implementation for hydrogen gas generation system 300 in FIG. 3.

In this example, hydrogen gas generation system 600 includes five reactors: reactor 601, reactor 602, reactor 603, reactor 604, and reactor 605. These reactors are located in cooling structure 606. In this example, cooling structure 606 is a physical structure in the form of a cooling jacket.

In this example, liquid ammonia is input into cooling structure 606 through coolant feedline 609. This liquid ammonia provides coolant for the different components within cooling structure 606 such as reactor 601, reactor 602, reactor 603, reactor 604, and reactor 605. This liquid ammonia travels to the ammonia inlet of reactor 601 through liquid ammonia feedline 607. In this example, pump 608 pumps the liquid ammonia through liquid ammonia feedline 607 into reactor 601. This pump is an example of a pressure system that generates a pressure differential to form pressurized liquid ammonia that enters the ammonia inlet of reactor 601.

As depicted, these reactors are connected in series. As depicted, the output of each reactor is a collection outlet that is connected to the ammonia inlet of the next reactor in the series. In this example, the collection outlet of reactor 601 is connected to the ammonia inlet of reactor 602 by liquid ammonia feedline 611; the collection outlet of reactor 602 is connected to the ammonia inlet of reactor 603 by liquid ammonia feedline 612; the collection outlet of reactor 603 is connected to the ammonia inlet of reactor 604 by liquid ammonia feedline 613; and the collection outlet of reactor 604 is connected to the ammonia inlet of reactor 605 by liquid ammonia feedline 614.

By sending the nitrogenous compounds output from one reactor into another reactor, further refinement of ammonia in the nitrogenous compounds can be used in gas generation. As a result more of the ammonia is converted into hydrogen gas.

The collection outlet of the last reactor, reactor 605, is output from cooling structure 606 by reactor system outlet 615. In this example, the nitrogenous compounds from reactor 605 can be recirculated into cooling structure 606, additional stages of cooling structures with reactors, or discarded.

As depicted, the hydrogen gas outlets of reactor 601, reactor 602, reactor 603, reactor 604, and reactor 605 are connected to hydrogen gas fuel line 620. This fuel line can be connected to a propulsion system in a platform such as an aircraft. This fuel line can be connected to a fuel cell in the propulsion system or other system that generates power or thrust for a platform.

Illustration of hydrogen gas generation system 600 in FIG. 6 is an example of one implementation for hydrogen gas generation system 202 in FIG. 2 and hydrogen gas generation system 300 in FIG. 3. This illustration is one example and not meant to limit the manner in which other examples can be implemented. For example, other illustrative examples can have other numbers of reactors such as 5 reactors or 10 reactors. In yet another illustrative example, hydrogen gas generation system 600 can have one or more cooling structures in addition to cooling structure 606 with reactors that also generate hydrogen gas. In yet another illustrative example, additional reactors can be present in cooling structure in parallel to the depicted reactors in which these additional reactors are connected in series to generate hydrogen gas.

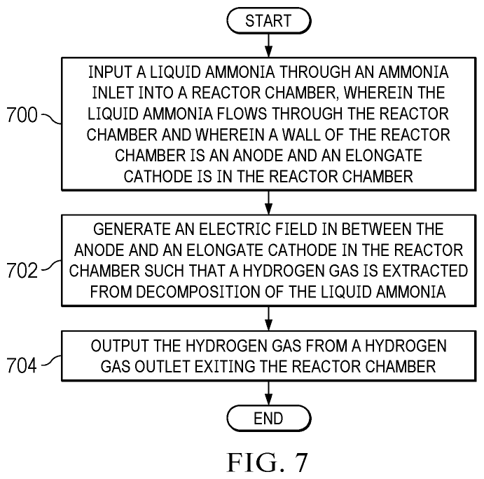

Turning next to FIG. 7, an illustration of a flowchart of a process for generating hydrogen gas is depicted in accordance with an illustrative embodiment. The process in FIG. 7 can be implemented in hydrogen gas generation system 202 in FIG. 2, hydrogen gas generation system 300 in FIG. 3, and hydrogen gas generation system 600 in FIG. 6.

The process begins by inputting a liquid ammonia through an ammonia inlet into a reactor chamber, wherein the liquid ammonia flows through the reactor chamber and wherein the wall of the reactor chamber is an anode and an elongate cathode is in the reactor chamber (operation 700). The process generates an electric field in between the anode and an elongate cathode in the reactor chamber such that a hydrogen gas is extracted from decomposition of the liquid ammonia (operation 702).

The process outputs the hydrogen gas from a hydrogen gas outlet exiting the reactor chamber (operation 704). The process terminates thereafter.

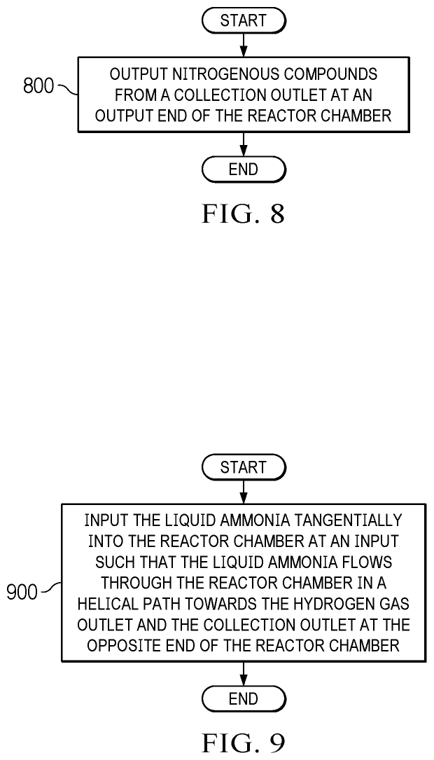

In FIG. 8, an illustration of a flowchart of a process for outputting nitrogenous compounds in generating nitrogen gas is depicted in accordance with an illustrative environment. The process in this figure is an example of an operation that can be performed with the operations in FIG. 7.

The process outputs nitrogenous compounds from a collection outlet at an output at the end of the reactor chamber (operation 800). The process terminates thereafter.

With reference next to FIG. 9, an illustration of a flowchart of a process for inputting liquid ammonia to generate hydrogen gas is depicted in accordance with an illustrative embodiment. The process in this figure is an example of an operation that can be performed with the operations in FIG. 7.

The process inputs the liquid ammonia tangentially into the reactor chamber at an input such that the liquid ammonia flows through the reactor chamber in a helical path towards the hydrogen gas outlet and the collection outlet at the opposite end of the reactor chamber (operation 900). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

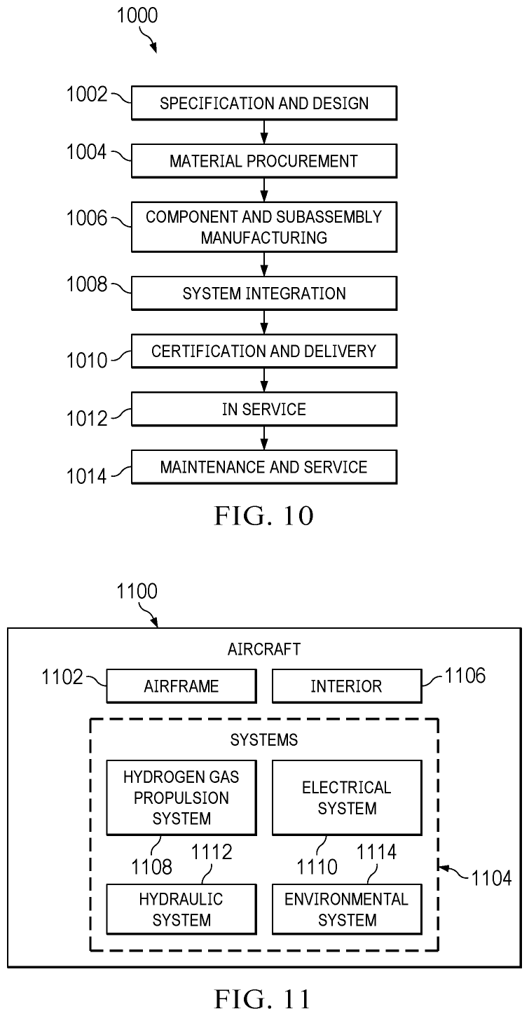

Illustrative embodiments of the disclosure may be described in the context of aircraft manufacturing and service method 1000 as shown in FIG. 10 and aircraft 1100 as shown in FIG. 11. Turning first to FIG. 10, an illustration of a block diagram of an aircraft manufacturing and service method is depicted in accordance with an illustrative embodiment. During pre-production, aircraft manufacturing and service method 1000 may include specification and design 1002 of aircraft 1100 in FIG. 11 and material procurement 1004.

During production, component and subassembly manufacturing 1006 and system integration 1008 of aircraft 1100 in FIG. 11 takes place. Thereafter, aircraft 1100 in FIG. 11 can go through certification and delivery 1010 in order to be placed in service 1012. While in service 1012 by a customer, aircraft 1100 in FIG. 11 is scheduled for routine maintenance and service 1014, which may include modification, reconfiguration, refurbishment, and other maintenance or service.

Each of the processes of aircraft manufacturing and service method 1000 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 11, an illustration of a block diagram of an aircraft is depicted in which an illustrative embodiment may be implemented. In this example, aircraft 1100 is produced by aircraft manufacturing and service method 1000 in FIG. 10 and may include airframe 1102 with plurality of systems 1104 and interior 1106. Examples of systems 1104 include one or more of hydrogen gas propulsion system 1108, electrical system 1110, hydraulic system 1112, and environmental system 1114. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1000 in FIG. 10.

In one illustrative example, components or subassemblies produced in component and subassembly manufacturing 1006 in FIG. 10 can be fabricated or manufactured in a manner similar to components or subassemblies produced while aircraft 1100 is in service 1012 in FIG. 10. As yet another example, one or more apparatus embodiments, method embodiments, or a combination thereof can be utilized during production stages, such as component and subassembly manufacturing 1006 and system integration 1008 in FIG. 10. One or more apparatus embodiments, method embodiments, or a combination thereof may be utilized while aircraft 1100 is in service 1012, during maintenance and service 1014 in FIG. 10, or both. The use of a number of the different illustrative embodiments may substantially expedite the assembly of aircraft 1100, reduce the cost of aircraft 1100, or both expedite the assembly of aircraft 1100 and reduce the cost of aircraft 1100.

For example, a hydrogen gas generation system can be manufactured during component and subassembly manufacturing 1006 and integrated into aircraft 1100 during system integration 1008. As another example, this type of hydrogen gas generation system can be added to aircraft 1100 to generate fuel for a hydrogen gas propulsion system in aircraft 1100 during maintenance and service 1014. This addition of the hydrogen gas generation system can be part of modification, reconfiguration, refurbishment, and other maintenance or service that occurs in maintenance and service 1014. In this illustrative example, the hydrogen gas generation system can operate during in service 1012 to supply gas as a fuel for hydrogen gas propulsion system 1108 in aircraft 1100.

Thus, illustrative examples provide a method, apparatus, and system for generating hydrogen gas. The hydrogen gas can be used as fuel or energy by platforms. The hydrogen gas can be used to provide power, thrust, or both for a platform. In one illustrative example, hydrogen gas generation system comprising a reactor chamber, an elongate cathode, an ammonia inlet, a hydrogen gas outlet, and a collection outlet. The reactor chamber has an input end and an output end. A wall of the reactor chamber between the input end and the output end is an anode. The elongate cathode extends between the input end and the output end through an interior of the reactor chamber. The ammonia inlet is positioned to introduce a liquid ammonia into the reactor chamber such that the liquid ammonia flows in a direction from the input end to the output end. The hydrogen gas outlet at the output end, wherein a hydrogen gas generated in the reactor chamber exits the reactor chamber through the hydrogen gas outlet. The collection outlet is at the output end. Nitrogenous compounds exit the reactor chamber through the collection outlet.

As a result, the generation of hydrogen gas in a platform such as an aircraft has advantages over current sources of hydrogen gas for propulsion systems generating thrust and power. In the illustrative examples, generating hydrogen gas from liquid ammonia on board an aircraft is more efficient in terms of volume and storage temperatures as compared to cryogenic hydrogen.

Further, the illustrative examples provide an increased rate in generating hydrogen. In one illustrative example, an ultrasonic transducer system can generate ultrasonic signals that increase the generation of hydrogen and de-gas anodes and cathodes. Further, a magnetic field generator can be implemented that generates magnetic fields that also increase the rate in generating hydrogen gas using the Lorenz force. Further, the use of the magnetic field generator does not require additional energy when materials such as permanent magnetic discs are used.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A hydrogen gas generation system comprising:
a reactor chamber having an input end and an output end, wherein a wall of the reactor chamber between the input end and the output end is an anode;
an elongate cathode extending between the input end and the output end through an interior of the reactor chamber;
an ammonia inlet positioned to introduce a liquid ammonia into the reactor chamber such that the liquid ammonia flows in a direction from the input end to the output end;
a hydrogen gas outlet at the output end, wherein a hydrogen gas generated in the reactor chamber exits the reactor chamber through the hydrogen gas outlet; and
a collection outlet at the output end, wherein nitrogenous compounds exit the reactor chamber through the collection outlet.

2. The hydrogen gas generation system of claim 1 further comprising:
an ultrasonic transducer system configured to generate ultrasonic signals that increases hydrogen generation rates within the reactor chamber and de-gas the anode and the elongate cathode.

3. The hydrogen gas generation system of claim 1 further comprising:
a magnetic field generator that generates a magnetic field in a field direction that is aligned with an axis extending centrally through the reactor chamber and centrally through the elongate cathode.

4. The hydrogen gas generation system of claim 3, wherein the magnetic field generator comprises:
a first disc magnet proximal to the ammonia inlet; and
a second disc magnet proximal to the hydrogen gas outlet.

5. The hydrogen gas generation system of claim 1, wherein the ammonia inlet is positioned to input the liquid ammonia tangentially into the reactor chamber such that the liquid ammonia flows in a helical path towards the output end.

6. The hydrogen gas generation system of claim 1, wherein a pressure differential is present in the liquid ammonia between the input end and the output end of the reactor chamber.

7. The hydrogen gas generation system of claim 1, wherein pressure differential is generated by a pressure system.

8. The hydrogen gas generation system of claim 1, wherein pressure differential is generated by a vacuum system.

9. The hydrogen gas generation system of claim 1, wherein an electric field generated between the anode and the elongate cathode causes the hydrogen gas to be generated from decomposition of the liquid ammonia.

10. The hydrogen gas generation system of claim 1, wherein the reactor chamber is located in a platform selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, and a building.

11. A hydrogen gas generation system comprising:
a reactor chamber having an input end and an output end, wherein a wall of the reactor chamber between the input end and the output end is an anode;
an elongate cathode extending between the input end and the output end through an interior of the reactor chamber;
an ammonia inlet positioned to input a pressurized liquid ammonia tangentially into the reactor chamber such that the pressurized liquid ammonia flows in a helical path towards the output end;
a hydrogen gas outlet at the output end;
a collection outlet at the output end, wherein nitrogenous compounds exit the reactor chamber through the collection outlet; and
an ultrasonic transducer system configured to generate ultrasonic signals that increases hydrogen generation rates within the reactor chamber.

12. The hydrogen gas generation system of claim 11, wherein the ultrasonic signals increase hydrogen generation rates within the reactor chamber and de-gas the elongate cathode and the anode.

13. The hydrogen gas generation system of claim 11 further comprising:
a magnetic field generator that generates a magnetic field in a direction that is aligned with an axis extending centrally through the reactor chamber, wherein the axis extends centrally through the elongate cathode.

14. The hydrogen gas generation system of claim 13, wherein the magnetic field generator comprises:
a first disc magnet proximal to the ammonia inlet; and
a second disc magnet proximal to the hydrogen gas outlet.

15. A hydrogen gas generation system comprising:
reactors, wherein each reactor in the reactors comprises:
a reactor chamber having an input end and an output end, wherein a wall of the reactor is an anode;
an elongate cathode extending between the input end and the output end through an interior of the reactor chamber;
an ammonia inlet positioned to input a pressurized liquid ammonia tangentially into the reactor chamber such that the pressurized liquid ammonia flows in a helical path towards the output end;
a hydrogen gas outlet at the output end;
a collection outlet at the output end, wherein nitrogenous compounds exit the reactor chamber through the collection outlet; and
an ultrasonic transducer system configured to generate ultrasonic signals that increases hydrogen generation rates within the reactor chamber, wherein the reactors are connected in series with the collection outlet of one reactor being connected to the ammonia inlet of a next reactor in the series.

16. The hydrogen gas generation system of claim 15 further comprising:
a cooling structure, wherein the reactors are located within the cooling structure.

17. The hydrogen gas generation system of claim 16, wherein:
the pressurized liquid ammonia is fed into the cooling structure prior to being pumped into a first reactor in the reactors.

18. The hydrogen gas generation system of claim 16, wherein the cooling structure with the reactors are located in a platform selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, and a building.

19. A hydrogen gas generation system comprising:
a reactor chamber having an input end and an output end;
an anode;
a cathode;
an ammonia inlet positioned to introduce a liquid ammonia into the reactor chamber such that the liquid ammonia flows in a direction from the input end to the output end;
a hydrogen gas outlet at the output end, wherein a hydrogen gas generated in the reactor chamber exits the reactor chamber through the hydrogen gas outlet; and
a collection outlet at the output end, wherein nitrogenous compounds exit the reactor chamber through the collection outlet.

20. The hydrogen gas generation system of claim 19, wherein:
a wall of the reactor chamber between the input end and the output end is the anode; and
the cathode is an elongate cathode extending between the input end and the output end through an interior of the reactor chamber.

21. The hydrogen gas generation system of claim 19, wherein:
the input end of the reactor chamber is the anode; and
the output end of the reactor chamber is the cathode.

22. A method of generating hydrogen gas, the method comprising:
inputting a liquid ammonia through an ammonia inlet into a reactor chamber, wherein the liquid ammonia flows through the reactor chamber and wherein a wall of the reactor chamber is an anode and an elongate cathode is in the reactor chamber;
generating an electric field in between the anode and the elongate cathode in the reactor chamber such that a hydrogen gas is extracted from decomposition of the liquid ammonia; and
outputting the hydrogen gas from a hydrogen gas outlet exiting the reactor chamber.

23. The method of claim 22 further comprising:
outputting nitrogenous compounds from a collection outlet at an output at end of the reactor chamber.

24. The method of claim 23, wherein inputting the liquid ammonia comprises:
inputting the liquid ammonia tangentially into the reactor chamber at an input such that the liquid ammonia flows through the reactor chamber in a helical path towards the hydrogen gas outlet and the collection outlet at the opposite end of the reactor chamber.
